(19) United States
(12) Patent Application Publication
(10) Pub. No.: US 2026/0081452 A1
(43) Pub. Date: Mar. 19, 2026

(54) SYSTEMS AND METHODS FOR GENERATING WAVEFORM PARAMETERS FOR A BATTERY CHARGING SIGNAL

(71) Applicant: Iontra Inc, Centennial, CO (US)

(72) Inventors: John Richard HOWLETT, III, Centennial, CO (US); Zhong WANG, Denver, CO (US); William E. CHECK, Denver, CO (US)

(21) Appl. No.: 19/327,607

(22) Filed: Sep. 12, 2025

Related U.S. Application Data
(60) Provisional application No. 63/694,513, filed on Sep. 13, 2024.

(51) Int. Cl. H02J 7/00

(52) U.S. Cl. CPC H02J 7/927; H02J 7/82; H02J 7/96

(57) ABSTRACT

Methods, systems, and devices are disclosed for generating a battery charging signal. A method includes generating an initial waveform having a voltage curve and a current curve, wherein the initial waveform includes a leading edge portion characterized by a leading edge parameter, a body portion characterized by a body parameter, and a rest portion characterized by a rest parameter. By comparing leading edge phase shifts and body phase shifts to leading edge thresholds and body thresholds, an adjusted leading edge, body, and rest parameters may be determined and saved for use in generating subsequent waveforms. A method of charging a battery includes charging a battery using a constant current mode, probing the battery with a probing signal and receiving a response signal from the battery, determining a resonance frequency from the response signal, and constructing a charging waveform based on the resonance frequency.

### CROSS-REFERENCE TO RELATED APPLICATION

This application claims priority to U.S. Provisional Patent Application No. 63/694,513, filed Sep. 13, 2024, entitled “SYSTEMS AND METHODS FOR GENERATING WAVEFORM PARAMETERS FOR A BATTERY CHARGING SIGNAL”, the entire disclosure of which is hereby incorporated by reference, for all purposes, as if fully set forth herein.

### TECHNICAL FIELD

Embodiments of the present invention generally relate to systems and methods for generating a charging signal that includes a repeating waveform. The shape of the repeating waveform is defined in part by waveform parameters (e.g., timing parameters and frequencies).

### BACKGROUND AND INTRODUCTION

Rechargeable batteries are widely used in electrically powered devices such as tools, lawn equipment, mobile computing devices, communication devices, portable electronic devices, household appliances, and electric and hybrid vehicles. Rechargeable batteries are limited by finite battery capacity and must be recharged upon depletion. Because the powered device must often be tethered to an outlet or a charging station during the recharging period, and in some cases may not be used during the recharging period, recharging a battery may be inconvenient to users. In some cases, the recharging period for a battery can last for hours.

High current charging methods have been developed to accelerate charge times. These fast charge systems rely on costly high-power electronics to deliver the required levels of charge current. Fast charging can lead to battery degradation and reduced battery performance over time. New charging signals that facilitate fast charging speeds and reduce damage to the battery are needed to improve user experience and reduce battery-related replacements and waste. Methods and systems that facilitate development of such charging signals for different types of batteries are also needed.

It is with these observations in mind, among others, that aspects of the present disclosure were conceived and developed.

### SUMMARY

Methods, systems, and devices are disclosed for generating a battery charging signal. A method includes generating an initial waveform having a voltage curve and a current curve, wherein the initial waveform includes a leading-edge portion characterized by a leading-edge parameter, a body portion characterized by a body parameter, and a rest portion characterized by a rest parameter. The method further includes determining a leading-edge phase shift between the voltage curve and the current curve for the leading edge portion, and comparing the leading edge phase shift to a first leading edge phase shift threshold. In response to determining the leading-edge phase shift is greater than the first leading edge phase shift threshold, an adjusted leading-edge parameter is determined. By comparing leading edge phase shifts and body phase shifts to leading edge thresholds and body thresholds, an adjusted leading-edge parameter, an adjusted body parameter, and an adjusted rest parameter may be determined and saved for use in generating subsequent waveforms.

A method of charging a battery includes charging a battery using a constant current mode, probing the battery with a probing signal and receiving a response signal from the battery, determining a resonance frequency from the response signal, and constructing a charging waveform based on the resonance frequency. One or more of a leading-edge parameter, a body parameter, and a rest parameter of the charging waveform may be based on the resonance frequency.

### BRIEF DESCRIPTION OF THE DRAWINGS

The various objects, features, and advantages of the present disclosure set forth herein will be apparent from the following description of embodiments of those inventive concepts, as illustrated in the accompanying drawings. Drawings presented herein are not necessarily to scale and may be representative of various features of an embodiment, with emphasis being placed on illustrating the principles and other aspects of the inventive concepts. Also, in the drawings the like reference characters may refer to the same parts or similar throughout the different views. It is intended that the embodiments and figures disclosed herein are considered illustrative rather than limiting.

FIG. 1 is a block diagram illustrating an example charge protocol generation workflow, in accordance with embodiments herein.

FIG. 2 shows a square wave pulsed charging signal, in accordance with embodiments herein.

FIG. 3 shows a charging signal having a shaped waveform, in accordance with embodiments herein.

FIGS. 4A-4D are example charging signals showing a progression of adjustments aimed at aligning voltage and current waveforms, in accordance with embodiments herein.

FIG. 5 is a block diagram illustrating an example waveform parameter generation workflow, in accordance with embodiments herein.

FIG. 6 is a plot showing imaginary impedance versus real impedance for different frequencies and different states of charge for a battery, in accordance with embodiments herein.

FIG. 7 is a plot showing imaginary impedance versus real impedance for different frequencies and different states of charge for a battery, in accordance with embodiments herein.

FIG. 8 is a Nyquist plot showing resonance frequency versus state of charge for a battery, in accordance with embodiments herein.

FIG. 9 illustrates the locations of resonance frequency, transfer frequency, and diffusion frequency on a plot of imaginary impedance versus real impedance, in accordance with embodiments herein.

FIG. 10 is an example charging signal with repeating waveforms with waveform timing parameters, in accordance with embodiments herein.

FIG. 11A is an example charging signal with repeating waveforms constructed using determined waveform timing parameters, in accordance with embodiments herein.

FIG. 11B is a plot showing power spectral density versus frequency, in accordance with embodiments herein.

FIG. 12 is a block diagram illustrating an example battery charging and probing workflow, in accordance with embodiments herein.

FIG. 13 is a diagram of a battery charging system configured to generate a shaped charging waveform, in accordance with embodiments herein.

### DETAILED DESCRIPTION

Battery longevity and charging speed can be greatly improved by using a charging signal that is optimized for a particular battery type. Optimizing a charging signal is challenging due to the many components within the battery, the size of the battery, the manufacturing of the battery, among other things, and the difficulty of directly measuring effects of a charging signal on the different components. For example, in some batteries, an anode is the most susceptible to deterioration over time, but it is difficult to directly measure responses of the anode to different charging signals. The present disclosure includes several approaches to developing an optimized charging signal using different types of battery data, and interpretations of the same, to represent processes occurring within the battery. Specifically, solutions discussed herein relate to determining timing parameters for different portions of a repeating waveform within a charging signal. Approaches described herein advantageously allow for the optimization of charging signals for specific batteries or even for specific conditions of the battery as characteristics change over the battery's life with increasing use.

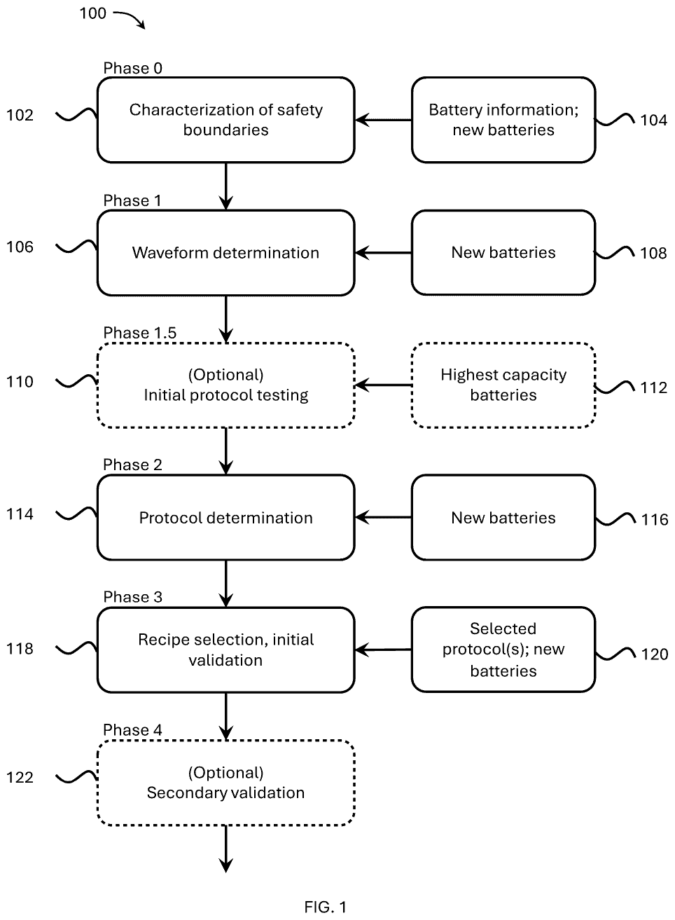

FIG. 1 shows a block diagram of a workflow 100 for developing a battery charging signal. The workflow 100 includes a first step 102 where a battery's safety boundaries are characterized. Inputs 104 to step 102 include new batteries (e.g., at least 2 new batteries) and information about the battery (e.g., information received from a battery manufacturer, customer, or battery specification data sheet, such as dV/dt used in terminating charge along with charge current and charge voltage parameters used in conventional constant current/constant voltage (CCCV) charging schemes). The batteries may be loaded into a battery cycler for experimentation which may include C-rate and voltage testing for the batteries. These tests may take place within a fume hood for safety purposes as batteries are pushed to their safety limits. The safety limits may include be characterized by determining characteristics such as temperature rise, temperature boundaries for charge and discharge, voltage rise, Constant Current (CC)/Constant Voltage (CV) voltage limited time, charging time, battery capacity, minimum and maximum discharge and charge voltages, maximum DC charge and discharge currents, and others at step 102.

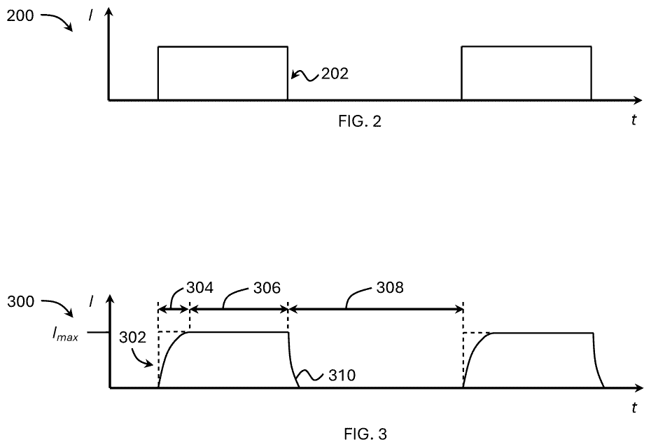

With the safety boundaries determined, the workflow 100 moves to step 106 where the shape of a charging waveform is determined. In general, pulsed charging signals described in the prior art have detrimental effects on a battery's cycle life. Such pulsed charging signals may include square wave pulses 202 as shown in the charging signal 200 of FIG. 2. A square wave pulse has a distinct approximately 90 degree leading edge, without any programmatic or functional shaping. The leading edge of a conventional square pulse is simply a function of switching on current flow, and the leading edge rises nearly instantaneously. Solutions for mitigating this disadvantage are described herein to avoid issues such as anode overpotential and plating.

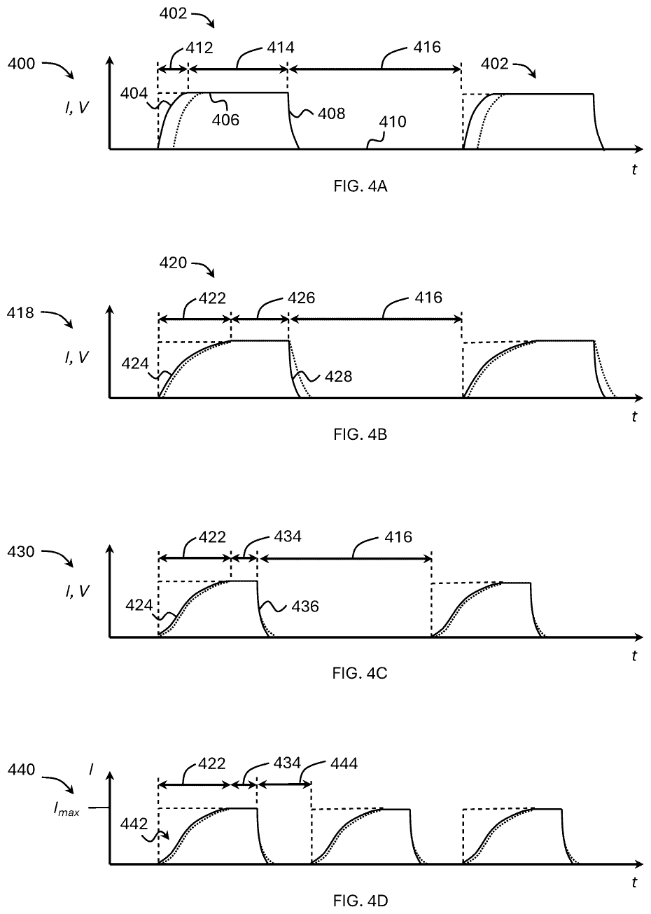

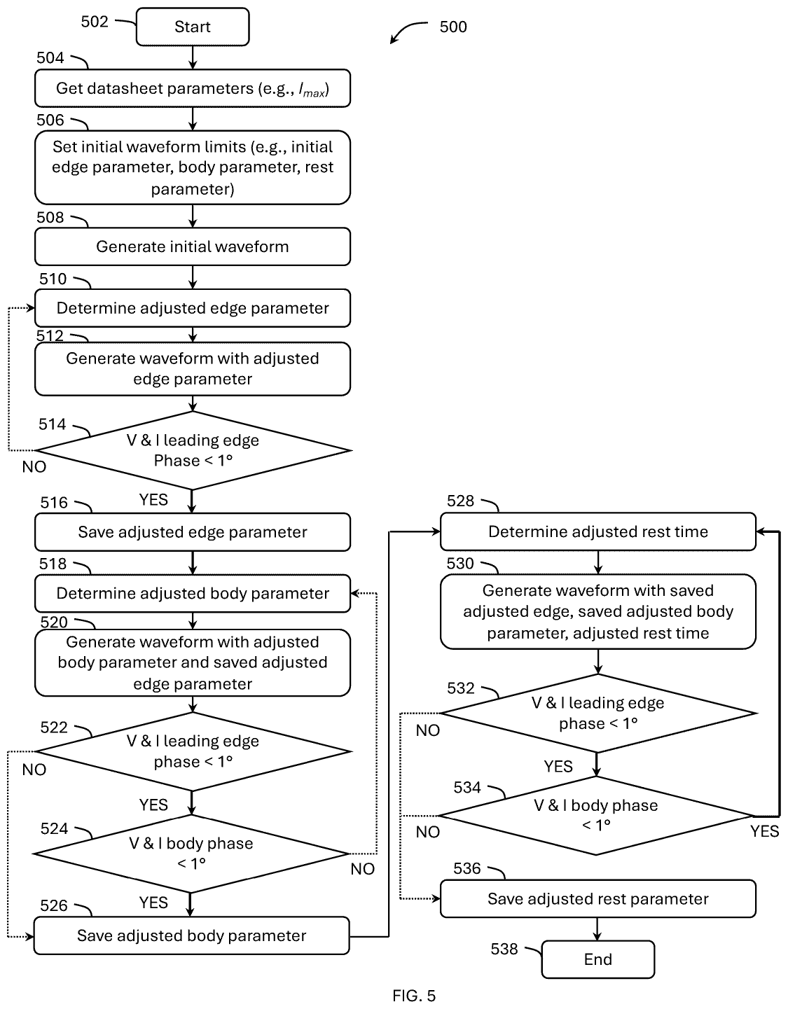

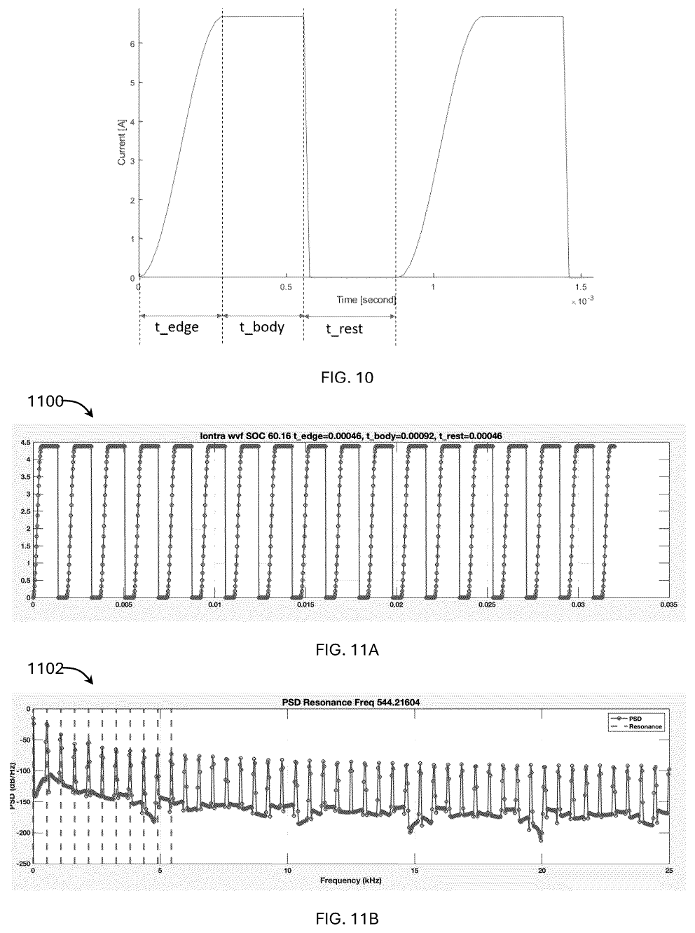

Referring to FIG. 3, an example charging signal 300 includes repeating waveforms 302. In contrast to the pulses 202, the waveforms 302 may include a leading-edge portion 304, a body portion 306, and a rest portion 308. A falling edge 310 may also be included and may be considered part of the body portion and/or part of the rest portion for the purposes of determining timing duration for each of the body portion 306 and rest portion 308. By determining a suitable leading-edge shape for the repeating waveforms 302, high currents (e.g., maximum charging current (max) delivered in repeating cycles can be applied to the battery for charging without triggering a plating process. Step 106 of the workflow 100 is aimed at finding an optimal leading-edge shape, which may in some examples be shaped like a sine wave form at some frequency, and waveform timing parameters (e.g., time durations for leading edge, body, and rest portions). However, in the case of shaping a leading edge according to a sine wave frequency, identifying these frequencies may be challenging because direct measurement of the anode's response to different charging signals is often difficult, impractical, or even impossible with common cycler or charging hardware setups. A detailed discussion of step 106 will be provided below with respect to FIGS. 4A-10.

Referring back to FIG. 1, the method may also involve step 110, which may be performed to test initial protocols, which testing may be performed on the highest capacity battery cells used in step 106. Initial protocol testing may include loading the high-capacity battery cells into cyclers within a safety shed and using waveform parameters from step 106 to charge the batteries. Initial estimates for charge times using the given waveform, feasible charging protocols, and/or preliminary cycle life data at aggressive charging conditions may be generated.

Workflow 100 continues at step 114 where a charging protocol is determined using new batteries included within input 116. The protocol determination step 114 is completed by loading batteries into a cycler which may be located within a safety shed. Performance characteristics such as charge time and cycle life are measured while the batteries are charged with the waveform from step 106. In some embodiments, the charging signal and waveform may be modified using information obtained during step 110 and/or using additional input (e.g., specified discharge current) from a customer, engineer, technician, or other charging recipe developer. Step 114 may output multiple viable charging protocols that achieve different performance characteristics. In some embodiments, the output charging protocols from step 114 are narrowed (e.g., by a customer or other user) to those which are most suited for the application or to those which have certain performance characteristics. In some embodiments, the multiple recipes may be selected over a broad range of performance scores so that several different options are provided and evaluated. For each tested protocol, step 114 may provide performance metrics such as charge times, cycle life and/or end-of-life predictions, and one or more selected viable charging recipes for further testing.

Workflow 100 continues at step 118 where the selected charging protocols from step 114 and new batteries are provided as input 120 for further charging recipe selection and initial validation. At step 118, the new batteries may be cycled from beginning to end of life. This process may be completed for each charging recipe as part of an initial validation process to confirm the selected charging recipe(s) perform as expected or within a predetermined tolerance. If the recipe performs within the predetermined tolerance (e.g., as determined by cycling performance over time, post-cycling tear down, or other measurement methods), the recipe passes the initial validation.

In some examples of the method, passing recipes may be provided to a secondary validation step 122. This validation step may be performed by a third-party laboratory, company, customer, or battery manufacturer to confirm expected performance using the passing battery charging recipes from step 118. If the recipes tested in step 122 performs within a predetermined tolerance, an externally validated charging recipe is provided as output by step 122.

Referring back to the waveform determination step 106 in workflow 100, waveform determination may be accomplished using several approaches. In general, the goal of the waveform determination step is to determine waveform characteristics such as timing parameters for each portion of the waveform (e.g., leading edge, body period, rest period) and a shape for the leading edge. Determination of the timing parameters and leading-edge shape may be guided at least in part by the battery charging hardware and its ability to generate shapes and timing. The hardware used to produce a charging signal (e.g., on a cycler or in the battery's desired application such as in a smart phone, power tool, electric vehicle, or other battery-powered device) may be limited in the shapes or frequencies it can produce. Thus, it is possible that some charging hardware may be unable to produce an ideal leading-edge shape or may lack the resolution to achieve certain timing parameters. Thus, the shape and/or timing parameters tested may be limited to those that are achievable by the hardware that will generate and deliver the charging signal to the battery.

In a first embodiment, input 108 to the waveform determination step 106 includes new batteries as well as battery information obtained during the characterization step 102. The cells may be loaded into cyclers (e.g., at ambient temperature) where tests are performed with different leading edge shapes and/or waveform timing parameters. The tested charging waveforms may be strategically selected using statistical insights or other design of experiments (DOE) approaches to narrow down a range in which an acceptable and/or optimal waveform for the battery may be found. One or more rounds of testing may be completed to obtain performance data for the batteries under the different testing conditions. Once testing is finished, each charging signal may be evaluated based on the results it achieved (e.g., battery cycle life, charging speed, physical condition of one or more components of the battery, etc.). One or more of the waveforms may be selected (e.g., based on one or more results metrics meeting a required threshold) for further testing and validation through the remaining steps of workflow 100.

In a second embodiment, electrochemical impedance spectroscopy (EIS) measurements may be performed on the battery and may be used to help narrow the range of frequencies tested from which the leading edge of the waveform may be determined. In an ideal scenario, the frequency associated with a zero crossing on an EIS plot represents an optimal leading-edge shape for a battery's charging waveform. However, because the EIS measurements are often affected by other components within the battery charging hardware and/or within the battery itself (e.g., components other than the anode), the zero-crossing frequency may not be the ideal frequency for the waveform's leading-edge shape. The zero-crossing frequency may instead be used as a reference point from which a frequency testing range is established. For example, the zero-crossing frequency may serve as a range boundary or a reference from which optimal frequency may be likely to occur (e.g., within a plus/minus frequency range of the zero-crossing reference point). This EIS-based zero crossing frequency approach to narrowing a range of frequencies to test may be used in combination with the above DOE approach.

In a third embodiment, battery models may be used alone or in combination with the DOE and/or EIS approaches to narrow the range of leading-edge shapes and/or timing parameters tested. Alternatively, models may be used to generate one or more predicted viable charging waveform or an optimal waveform for a given battery. For example, machine learning and/or physics-based models (e.g., developed using Python battery mathematical modeling “PyBaMM” tools) may be used to simulate battery responses to charging waveforms with different leading-edge shapes and waveform timing parameters. In some embodiments, the model may minimize phase shift between current and voltage curves as illustrated in the progression of FIGS. 4A-4D by following the method 500 described in the block diagram of FIG. 5.

FIG. 4A shows a measured current (solid line) and a measured voltage (dotted line) for a charging signal 400 that has waveforms 402. The current and voltage may be measured at the battery terminals, in one example. The waveforms 402 each include a leading edge 404, body 406, falling edge 408, and rest 410 similar to a waveform 302 in FIG. 3, although other shapes may be created depending on the particular battery and its application. The leading edge 404, body 406, and rest 410 have an associated leading-edge duration 412, body duration 414, and rest duration 416, respectively, measured in units of time. These durations may also be referred to herein as waveform timing parameters. In some embodiments, the falling edge 410 may have a relatively small duration such that it can be included in the body duration 414, rest duration 416, or can be split between the two. The waveform 402 may be formed according to steps 502-508 of method 500 with a goal of minimizing phase shift (e.g., which can be determined or otherwise correlated from a time difference between the measured current and measure voltage components of the charging waveform) and ensuring that a rate of voltage increase does not exceed a rate of current increase.

The method 500 starts at step 502 and datasheet parameters (e.g., known battery information or specifications, such as maximum charging current/max) or inputs 104 discussed above, are obtained at step 504. The battery information is used to set initial waveform limits or parameters in step 506. The initial waveform limits may include an initial edge parameter, a body parameter, and a rest parameter. Each of these parameters may include timing, current, and shape information for the different portions of the waveform. An initial waveform (e.g., waveform 402) is then generated at step 508 using the waveform limits from step 506.

In the example waveforms illustrated in FIG. 4, a phase shift between the current and the voltage exists at the leading edge 404 of waveforms 402. The phase shift is represented by the gap (which may be a time gap) between the solid current line and the dotted voltage line. A phase shift may be indicative of relatively high impedance, which may further indicate that charging is not occurring optimally and may cause degradation to the battery over time, particularly at the anode in a lithium-ion battery. Thus, adjustments to the charging waveform that reduce phase shift within the charging signal that is received at the battery (e.g., at the anode) can improve charging and battery performance. An adjusted edge parameter is determined at step 510 of the method 500 and a waveform with the adjusted edge parameter is generated at step 512. Adjusting the edge parameter may be accomplished by adjusting (e.g., increasing or decreasing) the timing (e.g., duration) of the leading-edge portion of the waveform. At decision block 514, the phase shift between current (I) and voltage (V) is compared to a predetermined threshold value (e.g., 0.5 degrees, 1 degree, or 2 degrees, in some examples). If the phase shift is less than the threshold value, the adjusted edge parameter is saved at step 516. If the phase shift is still larger than the threshold value, the method reverts back to step 510 where another adjusted edge parameter is determined and iterations continue. The iterations may continue until the phase shift is less than the selected phase threshold, or until a predetermined maximum number of iterations is met. The amount of phase shift that may be tolerated (e.g., determined by the phase threshold) may vary depending on the battery, required cycle life, expected charging speed, or other factors.

Referring to FIG. 4B, a charging signal 418 is illustrated having waveforms 420 that include an adjusted edge parameter 422. The adjusted edge parameter 422 reduces phase shift between current (solid line) and voltage (dotted line) curves at the leading edge 424. With the sum of the adjusted leading-edge duration 422 and the body duration 426 staying equal to the sum of leading-edge duration 412 and the body duration 414 (FIG. 4A), a phase shift is created at the falling edge 428 of waveform 420. The charging signal duty cycle may refer to the ratio of the non-zero current portion of the waveform (e.g., the sum of the leading-edge duration and the body duration) to the full waveform duration (e.g., the sum of the leading edge duration, the body duration, and the rest duration). Although the leading-edge durations 412, 422 and body durations 414, 426 changed from charging signal 400 to charging signal 418, the duty cycle remained constant.

Referring back to FIG. 5, an adjusted body parameter (e.g., is determined at step 518 and at step 520, a waveform is generated using the adjusted body parameter (e.g., a body parameter having increased or decreased duration) and the saved adjusted edge parameter from step 516. At decision block 522, phase shift between current and voltage curves at the leading edge is compared to a threshold (e.g., 1 degree). If the leading-edge phase shift is greater than or equal to the threshold, the adjusted body parameter is saved at step 526 (e.g., to prevent further deviation of the voltage and current curve alignment). If the leading-edge phase shift is less than the threshold, the method 500 continues to decision block 524 where the phase shift at the body is compared to a threshold (e.g., 1 degree in this example). If the body phase shift is less than the threshold, the adjusted body parameter is saved at step 526; however, if the body phase shift is greater than the threshold, the method 500 returns to step 518 where another adjusted body parameter is determined. This approach prioritizes maintaining the leading-edge phase shift at or near the selected threshold and, secondarily, optimizes the body phase shift alignment. In some embodiments, decision blocks may be re-ordered to prioritize body phase shift over leading edge phase shift, or to arrange the parameter priorities as desired.

FIG. 4C illustrates a charging signal 430 with waveforms 432 that include the adjusted leading-edge parameter 422 and an adjusted body parameter 434. The rest duration 416 may remain the same as illustrated in FIG. 4B, or alternatively, in other embodiments the full waveform duration or the duty cycle may remain constant. Notably, the phase shift at the leading edge remains minimal when compared to the charging signal 418 of FIG. 4B, and the phase shift at the body, including falling edge 436, is reduced to less than the selected body phase shift threshold of decision block 524.

Referring back to FIG. 5, additional steps may be completed to further optimize the battery charging signal. At step 528, an adjusted rest parameter is determined and a waveform is generated using the saved adjusted edge parameter, the saved adjusted body parameter, and the adjusted rest time at step 530. Steps 528 through 536 of method 500 may have the effect of increasing battery charging speed by decreasing the rest time (e.g., increasing duty cycle) associated with each waveform. Once the waveform is generated at step 530, leading edge phase shift is again compared to a threshold at decision block 532. The leading-edge phase threshold selected at decision block 532 may be the same or a different value than the threshold used in decision blocks 514 and/or 522. If the leading-edge phase shift is greater than the threshold, the adjusted rest parameter is saved at step 536 so that further increase of the leading-edge phase shift is prevented.

If the leading-edge phase shift is less than the threshold at decision block 532, method 500 moves to decision block 534 where body phase shift is compared to a body phase shift threshold. The body phase shift threshold at decision block may be the same as or different than the leading-edge phase threshold or other thresholds used at decision blocks earlier in the method 500. If the body phase shift is greater than or equal to the threshold at block 534, the rest time parameter is saved at block 536. If the body phase shift is less than the threshold, the method returns to block 528 where a new adjusted rest time is determined. The iterating may continue until either the leading-edge phase or the body phase meets or exceeds their respective selected thresholds or, in some embodiments, until a maximum allowable number of iterations has been completed. At that point, the most recent adjusted rest parameter is saved at block 536. With the leading edge, body, and rest parameters determined, the method 500 ends at block 538.

FIG. 4D illustrates a charging signal 440 having repeating waveforms 442. The waveforms 442 include the adjusted leading-edge parameter 422, adjusted body parameter 434, and an adjusted rest parameter 444. The adjusted rest parameter 444 may correspond to a minimum amount of time between active portions of adjacent waveforms that allows leading edge and body phase shift values to remain at or within an iteration of the selected leading edge and body phase shift thresholds, respectively. The charging signal 440 may represent an optimized charging signal that can be used to charge a battery quickly while minimizing degradation of battery components (e.g., anode, cathode, electrolyte, and/or other components) over its lifetime.

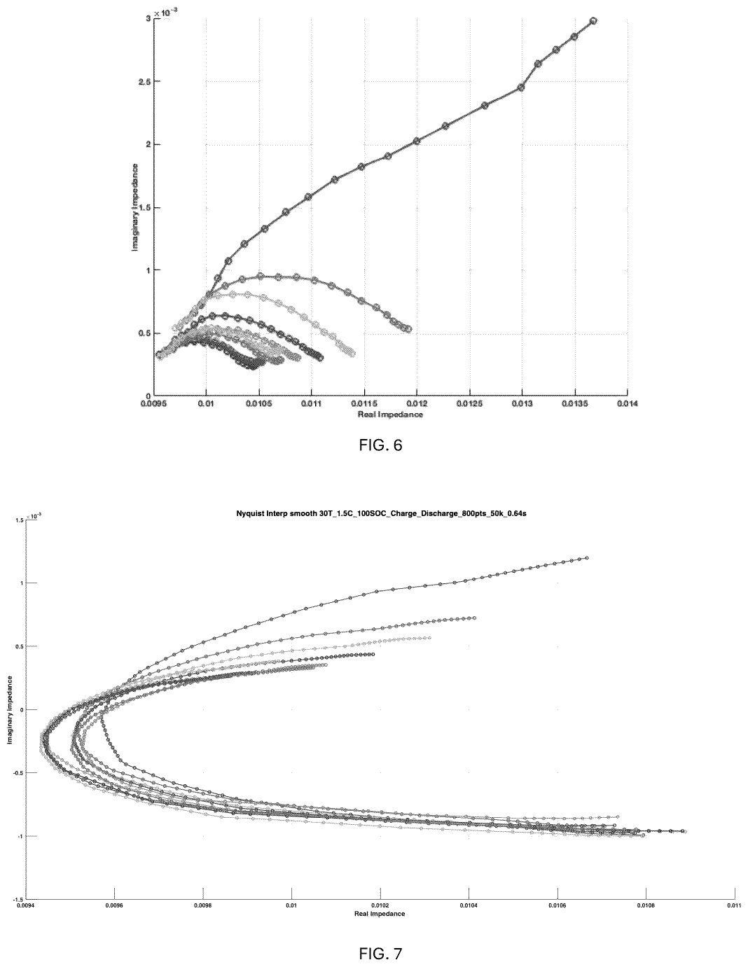

Referring now to FIGS. 6-12, in some embodiments, waveform parameters may be determined using data obtained in response to a battery probing signal. The probing signal may be a chirp signal that contains sinusoids at a plurality of frequencies (e.g., between 10-50 different frequencies, 20 frequencies, or 40 frequencies). In some embodiments, the range of frequencies represented in the probing waveform may be between 0.1 Hz to 10 kHz.

Each frequency may be represented by a segment with fixed data points in the time domain. The number and range of frequencies within the chirp signal may be determined by factors such as the hardware's ability to produce different frequencies, the maximum time permitted for disrupting charge so that the probing process can be performed, and/or known battery characteristics. The time to complete battery probing with a chirp signal may be less than one second, between one second and three seconds, between three and five seconds, or may be greater than five seconds, depending on the number of frequencies included, the sampling rate selected, and/or the allowable duration of the probing signal. Increasing sampling rate allows for the probing signal duration to be reduced and/or allows for additional unique frequencies to be included within the probing signal. In some embodiments, the sampling rate may be between 2 kHz and 100 kHz, such as for example, 5-10 kHz, 10-20 kHz, or 20-50 KHz.

During delivery of the probing signal, EIS may be performed to obtain impedance measurements for the battery in response to each of the frequencies included within the probing signal. The EIS measurements may be associated with each frequency in the probing signal using the fixed data points in the time domain that define bounds for each of the different frequencies. For each of the EIS measurements, a fast Fourier transform (FFT) may be performed on both the current and voltage waveforms to obtain complex impedance for each of the discrete frequencies included in the probing signal. The probing, measurement, and FFT processes may be performed multiple times during a charging signal (e.g., at predetermined state of charge (SOC) increments). FIG. 6 shows a graph of imaginary impedance versus real impedance at approximately 20 different frequencies (represented by dots) at multiple SOC increments (represented by the different lines). FIG. 7 shows the corresponding Nyquist plot with imaginary impedance and real impedance axes.

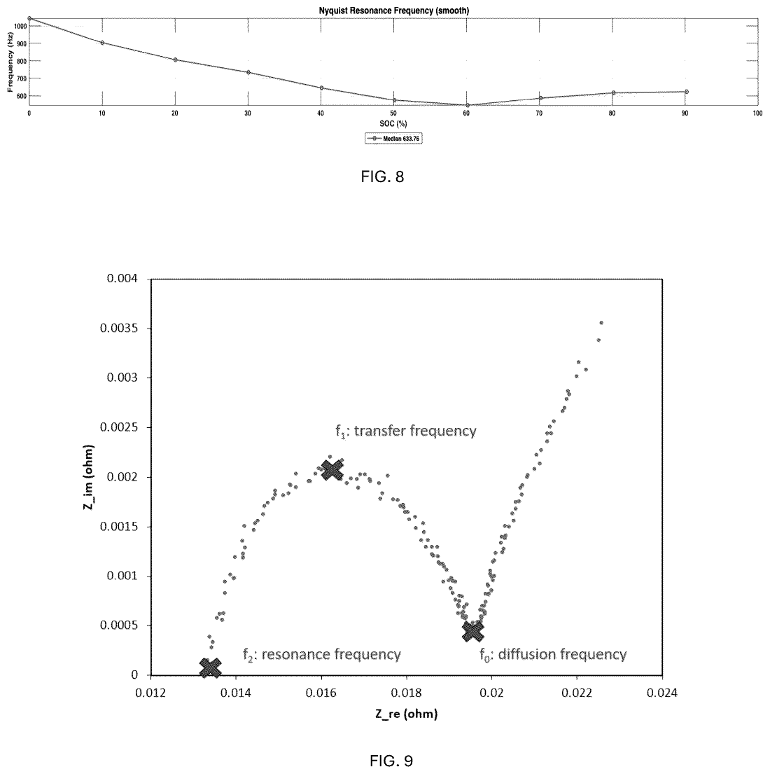

As shown in the resonance frequency (Hz) versus SOC (%) plot of FIG. 7, a resonance frequency at each SOC interval may be extracted from the data shown in the FIG. 6 plot. In some embodiments, depending on the range of frequencies contained within the probing signal, additional frequency values such as transfer frequency or diffusion frequency may also be obtained. Examples of these different frequencies are shown in the imaginary impedance versus real impedance plot of FIG. 8.

Resonance frequency is found at relatively high frequencies where imaginary impedance approaches zero. This indicates that a charging signal encounters minimal opposition to the movement of ions within the battery. At resonance frequency, the limitation of electron transfer reactions at the electrode/electrolyte interface may be negligible. Thus, the resonance frequency may be used as a starting point for constructing a charge signal with repeating waveforms.

As discussed above, parameters including leading edge timing (and/or shape), body timing, and rest period timing are needed to generate a repeating waveform with a shaped leading edge. In some embodiments, these timing parameters are determined as a function of the resonance frequency. The leading-edge duration (t_edge), body duration (t_body), and rest period duration (t_rest) may have different values or may be equal, as illustrated in FIG. 10. All of the durations may be given by Equation 1:

$${t}_{edge} = {t}_{body} = {t}_{rest} = 1 / ( Resonance frequency \times 2 ) . \qquad Eq . 1$$

One or more of the timing parameters may be calculated according to other formulas. For example, edge and rest duration may be given by Equation 2 and body duration may be given by Equation 3. An example charging signal 1100 generated according to these equations is illustrated in FIG. 11A and an associated power spectral density plot 1102 is illustrated in FIG. 11B.

$${t}_{edge} = {t}_{rest} = 1 / ( Resonance frequency \times 4 ) . \qquad Eq . 2$$

$${t}_{body} = 1 / ( Resonance frequency \times 2 ) . \qquad Eq . 3$$

In another example, edge duration and body duration may be given by Equation 4 while rest duration is determined according to Equation 5:

$${t}_{edge} = {t}_{body} = 1 / ( Resonance frequency \times 2 ) . \qquad Eq . 4$$

$${t}_{rest} = 1 / ( Resonance frequency ) . \qquad Eq . 5$$

In yet another example, edge and body duration may be determined according to Equation 6 while rest duration is governed by Equation 7:

$${t}_{edge} = {t}_{body} = 1 / ( Resonance frequency \times 4 ) . \qquad Eq . 6$$

$${t}_{rest} = 1 / ( Resonance frequency \times 2 ) . \qquad Eq . 7$$

Other variations are possible where edge and body timing are approximately equal and are different from rest timing, or where all three of the timing parameters are different. The parameters may be determined as a function of the resonance frequency. Because the resonance frequency may change over the course of a charging cycle and may further change over the life of the battery, this approach may allow for the waveform parameter timing to be adjusted to accommodate changes in SOC and/or aging of the battery by making adjustments based on a number of charge cycles or other indications of aging. This adaptive approach may help to extend the life and health of the battery.

Additionally, while some leading edge shapes conforming to a shape of a frequency of a sinusoid are illustrated, charging hardware or other system constraints may benefit from approximations of these curves. One or more linear ramps may be used such that a first current at a first time increases to a second current at a second time, where the first and second time points are separated by the edge duration time. Additional segments may be included in a linear piecewise approach such that multiple charge current ramps having different slopes are included within the edge duration period. Multiple time points and associated current values may be used as coordinates when constructing a leading edge with the piecewise approach. Other shapes, steps, curves, or functions may be used to generate or define the leading-edge shape.

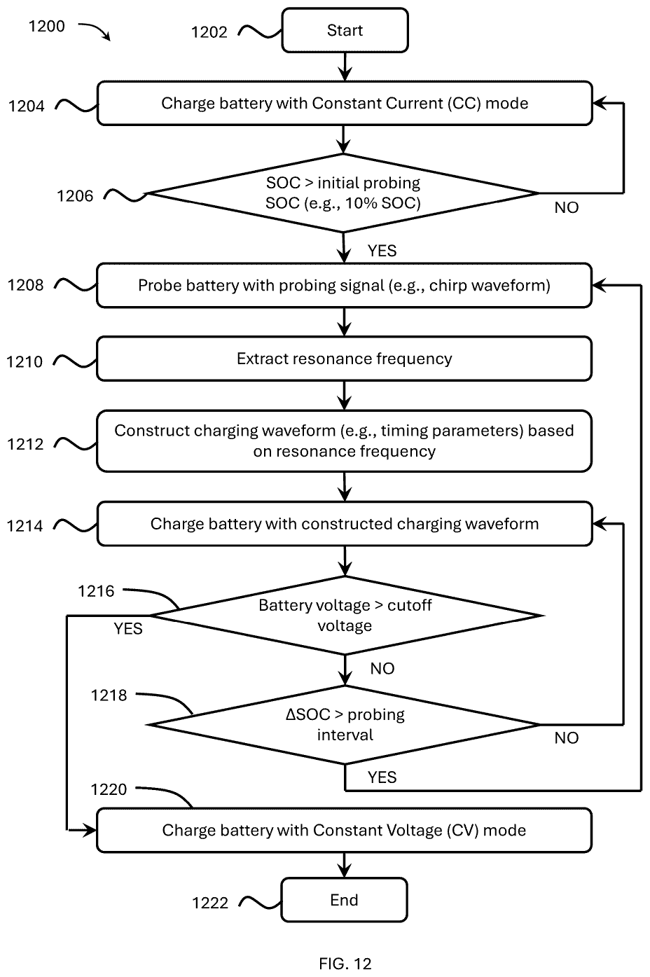

A charging procedure 1200 is shown in the block diagram of FIG. 12. The procedure starts at step 1202 and a battery is charged using an initial charging signal at step 1204. The initial charging signal may be a constant current charging signal or may be a waveform-based charging signal where the waveform has default or previously-determined timing parameters, such as discussed with regard to FIGS. 1-7 above. At decision 1206, the battery's state of charge (SOC) is compared to an initial probing SOC. The initial probing SOC may be a predetermined minimum SOC percentage at which a first probing signal is delivered to the battery. This may be any selected SOC, such as 5%, 10%, 15%, etc. In some embodiments, the initial probing SOC is between 5%-20%. If the SOC is less than or equal to the initial probing SOC, charging continues in the initial charging signal mode. If the SOC is greater than the initial probing SOC, the battery is probed using the probing signal at step 1208. The probing signal may be a signal, such as a chirp signal, that contains multiple different frequencies as discussed above.

At step 1210, a resonance frequency is extracted using the battery's response to the probing signal. The resonance frequency may be used to construct a charging waveform (e.g., may be used to define one or more waveform timing parameters) at step 1212. The battery is then charged using the constructed charging waveform at step 1214. At decision block 1216, a battery voltage measurement is compared to a cutoff voltage. The cutoff voltage may be a predetermined voltage level above which battery charging may continue in a constant voltage mode (step 1220). This step may continue until the battery reaches full charge or is within a threshold of full charge before ending the process at step 1222. If the battery voltage measurement is less than the cutoff voltage, the procedure continues at decision block 1218 where the battery's state of charge is compared to a selected probing interval. If the battery's change in state of charge has reached the next charging increment (e.g., at every 5% SOC increase), the process is routed back to step 1208 where a subsequent probing signal is delivered to the battery to begin the process of constructing an updated charging waveform for the current SOC level. If the change in SOC % does not exceed the probing interval, the process is routed back to step 1214 where the battery continues to charge using the previously constructed charging waveform.

In some embodiments, the various methods described above for generating a pulse, waveform, and/or charging signal may be carried out using a cycling system. Voltage and current measurements may be taken to obtain data for use in determining waveform parameters and timing. Because batteries are low impedance systems, it may be difficult to detect the voltage and therefore the phase relationship; specific hardware components (e.g., high accuracy analog-to-digital converters, components to scale voltage measurements, etc.) may be needed within the cycler system to detect and adjust waveform parameters. In some embodiments, the specific hardware components are included in a cycler built primarily for a research environment. Once the final charging waveform is selected (e.g., at step 118 of workflow 100), the information may be loaded into, or otherwise accessed by, a battery management system or other control system for use in charging a battery within a device.

Alternatively, one or more of the methods described may be carried out in real-time while the battery is installed within a device. The device may include hardware and software to support detection of phase shifts, rates of current and voltage change at the battery, physics-based and/or machine learning models may be used for this purpose. In some embodiments, one or more steps of the method may be performed using cloud-based data storage or processing.

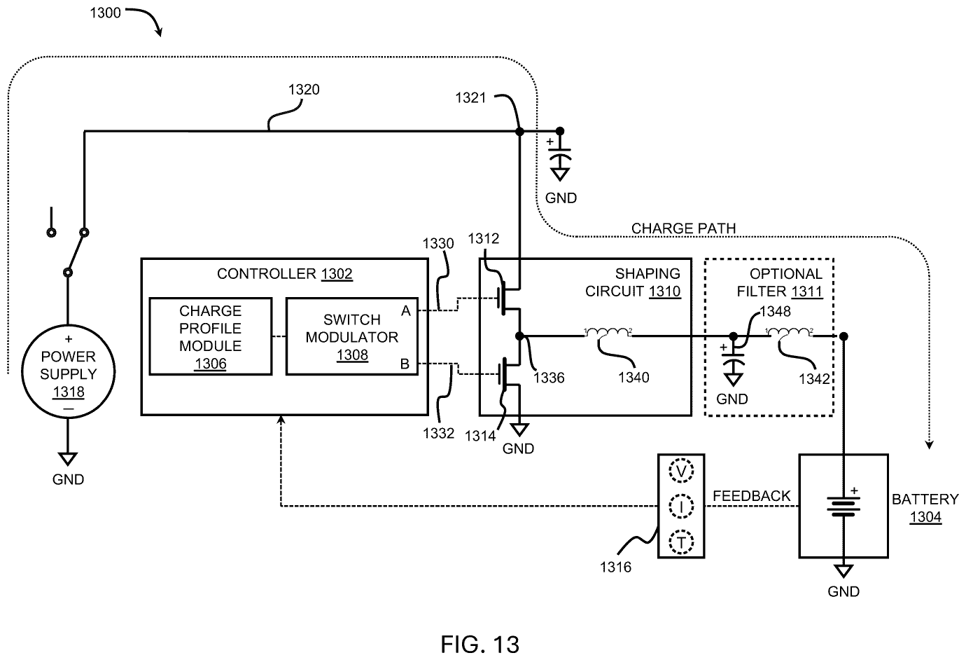

A circuit for implementing one or more of the generated charging signals is illustrated in FIG. 13. The circuit 1300 includes a charge path for charging a battery 1304 from power supply 1318 and along bus 1320 up to node 1321. Power source 1318 may generate an input charge supply in the form of an AC or DC input charge supply. In embodiments where power source 1318 generates an AC signal, an AC/DC converter may be included ahead of node 1321 to convert the input charge supply to a DC signal. A load path (not shown) may be included in the system 1300 and may be electrically connected at node 1321. This is omitted from the figure for clarity.

Along the charge path after node 1321, the system 1300 includes a controller 1302 in communication with a shaping circuit 1310. The controller 1302 may include a model 1306 in communication with a switch modulator 1308 such that the switch modulator 1308 may access information from the model 1306. In some embodiments, the model stores information about the battery 1304 such as battery type, battery conditions (e.g., state of charge (SOC), state of health (SOH), battery temperature, voltage, current, impedance, safety thresholds, etc.), environmental conditions (e.g., environmental temperature, moisture levels, etc.), or other factors that may affect charging of a battery. The model 1306 may receive feedback information about battery size, type, and/or conditions from a battery monitoring module 1316. The feedback information may include sensor measurements (e.g., temperature, voltage, current, etc.) and/or calculated or derived information (e.g., SOC, SOH, impedance, etc.). This feedback information may be used to update the model 1306, predict battery behavior, select a target shaped charging signal profile, and/or may be used to generate instruction signals via the switch modulator 108 for one or more switching elements within the shaping circuit 1310. The switch modulator 1308 may include, or may itself be, a pulse width modulator (PWM) and may further be configured to receive a clock input from a clock module (not shown).

In the system 1300, shaping circuit 1310 includes a first switching element 1312 and a second switching element 1314. The switching elements may be electrically controlled switching elements such as transistors, field effect transistors (FET), or more particularly metal-oxide-semiconductor field-effect transistors (MOSFET), Gallium Nitride (GaN) FETs, Silicon Carbide based FETs, or any other type of wired or wireless controllable switching element suitable for operating at the power levels of any given use case or implementation. The first and second switching elements 1312, 1314 each include a source, a gate, and a drain. The source of the first switching element 1312 is electrically coupled with the bus 1320 (e.g., at node 1321) and is configured to receive an input charge supply from power supply 1318. The gate of the first switching element 1312 is configured to receive a first instruction signal 1330 from switch modulator 1308 within controller 1302. The drain of first switching element 1312 is electrically coupled with a source of the second switching element 1314 (e.g., at a node 1336) such that the first and second switching elements are arranged in series. The gate of the second switching element 1314 is configured to receive a second instruction signal 1332 from the switch modulator 1308, and a drain of the second switching element is connected to ground.

Shaping circuit 1310 further includes at least one component downstream of the switching elements 1312, 1314. The additional component may be a first inductor 1340. An optional filter 1311 may be included following the shaping circuit 1310. The filter 1311 may include a capacitor 1348 and a second inductor 1342. The first inductor 1340 in addition to components within the optional filter may be configured to shape the cyclical charge supply generated at node 1336 by the controlled switching of switching elements 1312, 1314. The inductors 1340, 1342 and capacitor 1348 are configured to modify input charge supply received from node 1336 such that a shaped charge signal is generated for delivery to the battery 104 for charging.

In an example, the various embodiments discussed herein charge a battery cell by generating any desired charge signal that is shaped using the pair of transistors 1312, 1314 controlled through a switch modulator 1308 (e.g., a pulse width modulator, PWM). In particular, the pair of transistors may be controlled with a pulse-width modulation signal with a duty cycle. In general, the duty cycle of the PWM controlling the operation of the transistors correlates to a charge current applied to the battery, such that a higher duty cycle of the PWM control signal results in a higher current applied to charge the battery. The signal shaping generator may receive a target shaped charge signal and use the duty cycle of the PWM control signal to shape a charge signal for the battery that corresponds to the target shape. The shaping process of the charge signal be executed iteratively to gradually shape subsequent portions of the charge signal closer and closer to the target charge signal shape. This iterative process may include controlling the transistors at a first duty cycle of the PWM control signal, receiving a measurement of some aspect of the battery under charge, determining an error between the measurement and a target performance, and adjusting the duty cycle of the PWM control signal based on the determined error. The charge signal for the battery is therefore gradually shaped to match or approximate the shape of the target charge signal through multiple adjustments to the duty cycle of the PWM signal. This shaped charge signal may provide a more efficient charge signal for the battery that mitigates damaging effects of more traditional charge signals.

The term “battery” in the art and herein can be used in various ways and may refer to an individual cell having an anode and cathode separated by an electrolyte, solid or liquid, as well as a collection of such cells connected in various arrangements. A battery or battery cell is a form of electrochemical device. Batteries generally comprise repeating units of sources of a countercharge and electrode layers separated by an ionically conductive barrier, often a liquid or polymer membrane saturated with an electrolyte. These layers are made to be thin so multiple units can occupy the volume of a battery, increasing the available power of the battery with each stacked unit. Although many examples are discussed herein as applicable to a battery, it should be appreciated that the systems and methods described may apply to many different types of batteries ranging from an individual cell to batteries involving different possible interconnections of cells, such as cells coupled in parallel, series, and parallel and series. For example, the systems and methods discussed herein may apply to a battery pack comprising numerous cells arranged to provide a defined pack voltage, output current, and/or capacity. Moreover, the implementations discussed herein may apply to different types of electrochemical devices such as various different types of lithium batteries including but not limited to lithium-metal and lithium-ion batteries, lead-acid batteries, various types of nickel batteries, and solid-state batteries of various possible chemistries, to name a few. The various implementations discussed herein may also apply to different structural battery arrangements such as button or “coin” type batteries, cylindrical battery cells, pouch battery cells, and prismatic battery cells.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments, also referred to as implementations or examples, described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment”, or similarly “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

What is claimed:

1. A method of generating a battery charging signal, the method comprising:
generating an initial waveform comprising a voltage curve and a current curve, wherein the initial waveform comprises repeating charge portions each comprising a leading-edge portion characterized by a leading-edge parameter and a body portion following the leading-edge portion characterized by a body parameter, and a rest portion following the body portion characterized by a rest parameter;
determining a leading-edge phase shift between the voltage curve and the current curve for the leading edge portion;
comparing the leading-edge phase shift to a first leading-edge phase shift threshold; and
in response to determining the leading-edge phase shift is greater than the first leading edge phase shift threshold, determining an adjusted leading-edge parameter.

2. The method of claim 1, further comprising:
generating a second waveform using the adjusted leading edge parameter;
iterating comparing the leading-edge phase shift to the first leading edge phase shift threshold and determining the adjusted leading-edge parameter until the leading-edge phase shift meets the first leading edge phase shift threshold; and
saving the adjusted leading-edge parameter associated with the leading-edge phase shift that meets the first leading edge phase shift threshold.

3. The method of claim 2, wherein the leading-edge parameter is a first time between initiation of the leading edge and when a voltage or current of the leading edge meets the body portion and the adjusted leading-edge parameter is a second time, greater or less than the first time, between initiation of the leading edge and when the voltage or current of the leading edge meets the body portion.

4. The method of claim 3, further comprising:
generating a third waveform using the adjusted leading-edge parameter and an adjusted body parameter;
comparing the leading-edge phase shift of the third waveform to a second leading edge phase shift threshold; and
saving the adjusted body parameter.

5. The method of claim 4, further comprising:
determining that the leading-edge phase shift of the third waveform meets the second leading edge phase shift threshold;
determining a body phase shift between the voltage curve and the current curve for the body portion of the third waveform; and
comparing the body phase shift to a first body phase shift threshold.

6. The method of claim 5, further comprising determining that the body phase shift meets the first body phase shift threshold.

7. The method of claim 5, further comprising:
determining that the body phase shift is greater than the first body phase shift threshold; and
in response to determining that the body phase shift is greater than the first body phase shift threshold, iterating the determining the adjusted body parameter and the comparing the body phase shift to the first body phase shift threshold until the body phase shift meets the first body phase shift threshold.

8. The method of claim 4, further comprising:
generating a fourth waveform using the saved adjusted leading-edge parameter, the saved adjusted body parameter, and an adjusted rest parameter;
comparing the leading-edge phase shift of the fourth waveform to a third leading edge phase shift threshold; and
saving the adjusted rest parameter.

9. The method of claim 8, further comprising determining that the leading-edge phase shift of the fourth waveform meets the third leading edge phase shift threshold.

10. The method of claim 8, further comprising:
determining that the leading-edge phase shift of the fourth waveform is less than the third leading edge phase shift threshold;
determining the body phase shift of the fourth waveform; and
comparing the body phase shift of the fourth waveform to a second body phase shift threshold.

11. The method of claim 10, further comprising determining that the body phase shift of the fourth waveform meets the second body phase shift threshold.

12. The method of claim 10, further comprising:
determining that the body phase shift of the fourth waveform is greater than the second body phase shift threshold; and
in response to determining that the body phase shift of the fourth waveform is greater than the second body phase shift threshold, iterating the determining the adjusted rest parameter and the comparing the body phase shift of the fourth waveform to the second body phase shift threshold until the body phase shift meets the second body phase shift threshold.

13. The method of claim 8, further comprising generating a fifth waveform using the saved adjusted leading-edge parameter, the saved adjusted body parameter, and the saved adjusted rest parameter.

14. A method of charging a battery, the method comprising:
charging a battery using a constant current mode;
probing the battery with a probing signal and receiving a response signal from the battery;
determining a resonance frequency from the response signal; and
constructing a charging waveform based on the resonance frequency.

15. The method of claim 14, further comprising charging the battery using the constructed charging waveform.

16. The method of claim 15, further comprising:
determining a battery voltage is greater than a cutoff voltage threshold; and
charging the battery using a constant voltage mode.

17. The method of claim 16, further comprising:
determining the battery voltage is less than the cutoff voltage threshold;
determining that a state of charge of the battery is greater than a probing interval;
performing a second probing of the battery with the probing signal;
receiving a second response signal from the battery;
determining a second resonance frequency from the second response signal; and
constructing a second charging waveform based on the second resonance frequency.

18. The method of claim 17 further comprising charging the battery with the second constructed charging waveform.

19. The method of claim 15, wherein the constructed charging waveform comprises an edge parameter and a body parameter, wherein at least one of the edge parameter and the body parameter is a function of the resonance frequency.

20. The method of claim 19, wherein at least one of the edge parameter and the body parameter is inversely related to the resonance frequency.

21. The method of claim 19, further comprising a rest parameter, wherein the rest parameter is a function of the resonance frequency.

22. The method of claim 21, wherein the rest parameter is inversely related to the resonance frequency.
